(19) United States
(12) Patent Application Publication
(10) Pub. No.: US 2017/0111519 A1
(43) Pub. Date: Apr. 20, 2017

(54) Redirecting Billing in Radio Network

(71) Applicant: TELEFONAKTIEBOLAGET LM ERICSSON (PUBL), Stockholm (SE)

(72) Inventors: Bengt Lindoff, Bjärred (SE); Iwe Lingström, Kalmar (SE); Leif Wilhelmsson, Dalby (SE)

(21) Appl. No.: 15/128,514

(22) PCT Filed: Mar. 27, 2014
(86) PCT No.: PCT/EP2014/056156

§ 371 Date: Sep. 23, 2016

(51) Int. Cl. H04M 15/00; H04L 12/14; H04M 15/02

(52) U.S. Cl. CPC H04M 15/8033; H04M 15/09; H04M 15/888; H04M 15/85; H04L 12/1432; H04W 84/12

(57) ABSTRACT

The present disclosure relates to a method in a network node (1) of a communication network (5). The method comprises determining from signalling with a cellular RAN (4) and/or a wireless transceiver (3) that a radio device (2) is within range (6) of the wireless transceiver, said radio device being connected to the communication network over the cellular RAN. The method also comprises redirecting, through signalling with one or more billing servers (7) connected to the communication network, at least some billing for resources used by the radio device via the cellular RAN, from a first subscription to a second subscription, as a result of said determining that the radio device is within range of the wireless transceiver. Upon determining from signalling over the cellular RAN (4) and/or with the wireless transceiver (3) that the radio device (2) is no longer within the range (6) of the wireless transceiver (3), there is assigned a limitation criterion for the redirecting (402) of the at least some billing associated with the data communication over the cellular RAN for resources used by the radio device (2), and the redirecting (402) of the at least some billing associated with data communication over the cellular RAN for resources used by the radio device (2) is terminated, through signalling with the one or more billing servers (7) connected to the communication network, when the limitation criterion is fulfilled.

### TECHNICAL FIELD

The present disclosure relates to methods and devices for billing in a radio communication network.

### BACKGROUND

Today, many public places like restaurants, trains, airports etc. provide data communication with Internet over wireless access through the use of Wi-Fi, or wireless local area network (WLAN). Wireless access is often necessary in these places, and they might be provided for free or for a rate/fee. To provide to wireless access, an installation and also maintenance is required. Sometimes these installations do not really work well, either because of poor installation or simply because too many users are using the Wi-Fi network.

With a Wi-Fi network which does not work properly, the users might simply not have access, but more commonly is that the user instead is forced to use cellular radio access.

Since sometimes the public place has charged for data communication over wireless access, a solution which implies that the user in fact solves the problem by using cellular access is not satisfactory. In particular when the mobile operator has put a so-called data cap on the subscription. A data cap means that the user might use up to e.g. 10 GB/month of data communication and for data communication above this limit the user will have to pay extra or the throughput may be reduced to e.g. 100 kb/s. Thus, even if the obtained data rate is OK, the user will effectively pay for the data although already having paid for free wireless access via Wi-Fi.

US 2006/277312 discloses a range-based licensing system in which content can be provided to a user terminal based on the location. The system uses the range of a transmitter to define an area in which a promoted service will be authorized. The coverage area is defined by the range of the transmitter, such as a wireless access point. The disclosure thus solves a problem of providing a specific service in a predetermined geographical area. However, the disclosure is not related to solving a problem of overloaded Wi-Fi hotspots.

US2009/0203351 discloses a method for allowing differentiated taxes for telephone calls, i.e. voice service, at different location areas. It also discloses method for how to handle the taxing policy when a telephone terminal goes out of the location during an ongoing call. However, data communication over wireless access is very different from voice calls. During voice calls, the telephone terminal is in active state w.r.t connection to the NW node (cellular system) until the call is released, then the terminal goes to idle mode w.r.t the to cellular system.

It is therefore a desire to provide a technical approach taking care of the intermittent nature of data traffic, i.e. bursty data traffic, for a service utilising the data traffic, which a user experiences as an ongoing service, e.g. chat, emailing, browsing, etc., for billing cellular radio access traffic such that both the party charging for traffic in its premises and the user coming and leaving the premises experience a fair billing and service, respectively.

### SUMMARY

Today Wi-Fi/WLAN access is provided in many public places, either for free, for a rate or for a fee. However, often the performance is not acceptable. A remedy to this is that the user uses cellular radio access instead.

However, at the same time, flat rate is replaced by a cap on the maximum used data amount per month for many cellular subscriptions. Thus, even if wireless access is obtained via cellular radio, it might be at significant cost. Alternatively, if the subscription is such that the data rate is reduced once the cap is reached, the obtained performance might not suffice.

This problem is solved in accordance with the present disclosure by ensuring that the cost associated with the data over cellular radio access is taken, partly or fully, by the provider of the WLAN access, even if the physical bearer is not provided by the WLAN provider. That is, data that is consumed over the cellular radio access is paid for by the WLAN provider and not by the user as long as certain restrictions are fulfilled, or alternatively the cost is shared.

In accordance with the present disclosure, a radio device, e.g. a user equipment (UE), is able to use a cellular radio network, while the cost associated with the use of the cellular network is not fully covered by a subscription of the radio device during certain circumstances. Specifically, based on some parameter like time, MAC-addresses, device identifiers or locations, the cellular network should be informed that charging should be redirected, fully or partly to someone else. The reason for redirection of the to cost might be based on location, time, or something else.

The inventors have found that there is a desire to provide a technical approach where both the party being charged for traffic in its premises and the user coming and leaving the premises experience a fair billing and service, respectively, for terminating the redirection of billing, taking care of the intermittent nature of data traffic, i.e. bursty data traffic, for a service utilising the data traffic, which a user experiences as an ongoing service, e.g. chat, emailing, browsing, etc., for billing.

According to an aspect of the present disclosure, there is provided a method in a network node of a communication network. The method comprises determining from signalling over a cellular radio access network (RAN) and/or with a wireless transceiver that a radio device is within range of the wireless transceiver. The radio device is connected to the communication network over the cellular RAN. The method also comprises redirecting, through signalling with one or more billing servers connected to the communication network, at least some billing associated with data communication over the cellular RAN for resources used by the radio device over the cellular RAN, from a first subscription to a second subscription, as a result of said determining that the radio device is within range of the wireless transceiver. Thereafter, the method comprises determining from signalling over the cellular RAN and/or with the wireless transceiver that the radio device is no longer within the range of the wireless transceiver, and then assigning a limitation criterion for the redirecting of the at least some billing associated with the data communication over the cellular RAN for resources used by the radio device, and terminating, through signalling with the one or more billing servers connected to the communication network, the redirecting of the at least some billing associated with data communication over the cellular RAN for resources used by the radio device when the limitation criterion is fulfilled.

The limitation criterion may comprise a predefined time period starting from the determining that the radio device was within range of the wireless transceiver.

The limitation criterion may additionally or alternatively comprise a set of limitations comprising any combination of maximum time, maximum data amount, and limitation to IP address, wherein the redirecting is terminated once any of the limitations of the set of limitations is reached.

The method may further comprise transmitting a notification to the radio device when it is determined from the signalling over the cellular RAN and/or with the wireless transceiver that the radio device is no longer within the range of the wireless transceiver.

The notification may include information about the set of limitations.

The radio device may have said first subscription for billing use of resources via the cellular RAN, and said second subscription for billing use of resources via the cellular RAN may be associated with the wireless transceiver. The second subscription for billing use of resources via the cellular RAN may be held by an operator of a WLAN associated with the wireless transceiver.

The wireless transceiver may be a Bluetooth transceiver; a wireless local area network, WLAN, transceiver; or a radio frequency identification, RFID, transceiver, each using a radio communication technology for communicating with the radio device, which is different than a radio access technology, RAT, used by the cellular RAN.

The wireless transceiver may be configured for communicating with the radio device in network assisted peer device-to-device, D2D, communication, and the determining that the radio device is within range of the wireless transceiver may comprise determining whether the radio device and the wireless transceiver are in range for peer D2D communication, wherein the redirecting is based on said determining whether the radio device and the wireless transceiver are in range for peer D2D communication.

The determining that a radio device is within range of a wireless transceiver may comprise receiving a message from the wireless transceiver indicating that the radio device is within range of the wireless transceiver.

The determining that a radio device is within range of a wireless transceiver may comprise receiving a message from the radio device indicating that it is within range of the wireless transceiver.

According to another aspect of the present disclosure, there is provided a network node for a communication network. The node comprises communication circuitry enabled for signalling over a cellular RAN and/or with a wireless transceiver and with one or more billing servers connected to the communication network. The node also comprises processor circuitry, and a storage unit storing instructions that, when executed by the processor circuitry, cause the node to determine from signalling over the cellular RAN and/or with the wireless transceiver that a radio device is within range of the wireless transceiver. The radio device is connected to the communication network over the cellular RAN. The node is also caused to redirect, through signalling with the one or more billing servers connected to the communication network, at least some billing associated with data communication over the cellular RAN for resources used by the radio device over the cellular RAN, from a first subscription to a second subscription, as a result of said determining that the radio device is within range of the wireless transceiver. The node is thereafter caused to determine from signalling over the cellular RAN and/or with the wireless transceiver that the radio device is no longer within the range of the wireless transceiver, and then to assign a limitation criterion for the redirecting of the at least some billing associated with the data communication over the cellular RAN for resources used by the radio device, and terminate, through signalling with the one or more billing servers connected to the communication network, the redirecting of the at least some billing associated with data communication over the cellular RAN for resources used by the radio device when the limitation criterion is fulfilled.

The network node may be configured for performing an embodiment of a method of the present disclosure.

The limitation criterion may comprise a predefined time period arranged to start from the determination that the radio device was within range of the wireless transceiver.

The limitation criterion may comprise a set of limitations comprising any combination of maximum time, maximum data amount, and limitation to IP address, wherein the redirection is terminated once any of the limitations of the set of limitations is reached.

The network node may further be arranged to transmit a notification to the radio device when it is determined from the signalling over the cellular RAN and/or with the wireless transceiver that the radio device is no longer within the range of the wireless transceiver.

The notification may include information about the set of limitations.

According to another aspect of the present disclosure, there is provided a computer program product comprising computer-executable components for causing a network node to perform a method as demonstrated in an aspect above when the computer-executable components are run on processor circuitry comprised in the network node.

It is an advantage of some embodiments of the present disclosure that they allow billing of cellular data access to partly or fully be redirected to another subscription if a certain criterion is met. A WLAN provider may then e.g. accept cost for cellular access within an area covered by the WLAN if the capacity of the WLAN is exceeded. Some embodiments of the present disclosure allows different parties to provide free or subsidised wireless access without the need for costly installation and maintenance of hot spot networks like Wi-Fi. Alternatively, they allow for a good complement to another system, like Wi-Fi, in case this latter system does not work properly or is overloaded. Additionally, they will also allow advanced end user cost control and revenue sharing between subscriptions based on for example devices, capabilities etc.

It is an advantage of some embodiments of the present disclosure that they provide a technical approach where both the party charging for traffic in its premises and the user coming and leaving the premises experience a fair billing and service, respectively, for terminating the redirection of billing, taking care of the intermittent nature of data traffic, i.e. bursty data traffic, for a service utilising the data traffic, which a user experiences as an ongoing service, e.g. chat, emailing, browsing, etc., for billing.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic illustration of a communication system including a communication network in accordance with an embodiment of the present disclosure.

FIG. 2 is a schematic block diagram of an embodiment of a network node of the present disclosure.

FIG. 3 is a schematic block diagram of an embodiment of a radio device or wireless transceiver of the present disclosure.

FIG. 4 is a schematic flow chart of an embodiment of a method of the present disclosure.

FIG. 5 is a schematic illustration of an embodiment of a computer program product of the present disclosure.

FIG. 6 is a schematic illustration of a communication system including a communication network in accordance with an example embodiment of the present disclosure.

FIG. 7 is a schematic illustration of a communication system including a communication network in accordance with an example embodiment of the present disclosure.

FIG. 8 is a schematic illustration of a communication system including a communication network in accordance with an example embodiment of the present disclosure.

FIG. 9 is a schematic flow chart of an example embodiment of a method of the present disclosure.

### DETAILED DESCRIPTION

Embodiments will now be described more fully hereinafter with reference to the accompanying drawings, in which certain embodiments are shown.

However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

It is therefore a desire to provide a technical approach for billing such that both the party charging for data traffic in its premises and the user coming and leaving the premises experience a fair billing and service, respectively. “Premises” should in this context be construed as some boundaries, for which the party charging for data traffic is prepared to pay at least a fraction of the costs for the data traffic, and need not be a building or fixed position. Consider for example a petrol or food provider chain which offers to pay for to data traffic for a customer on a route from one of its stations to another, e.g. along a highway. “Billing” in this document may in some embodiments refer to not only billing per se but may also/alternatively consider different other aspects including rating and charging; prepaid and post-paid; real-time and hot billing.

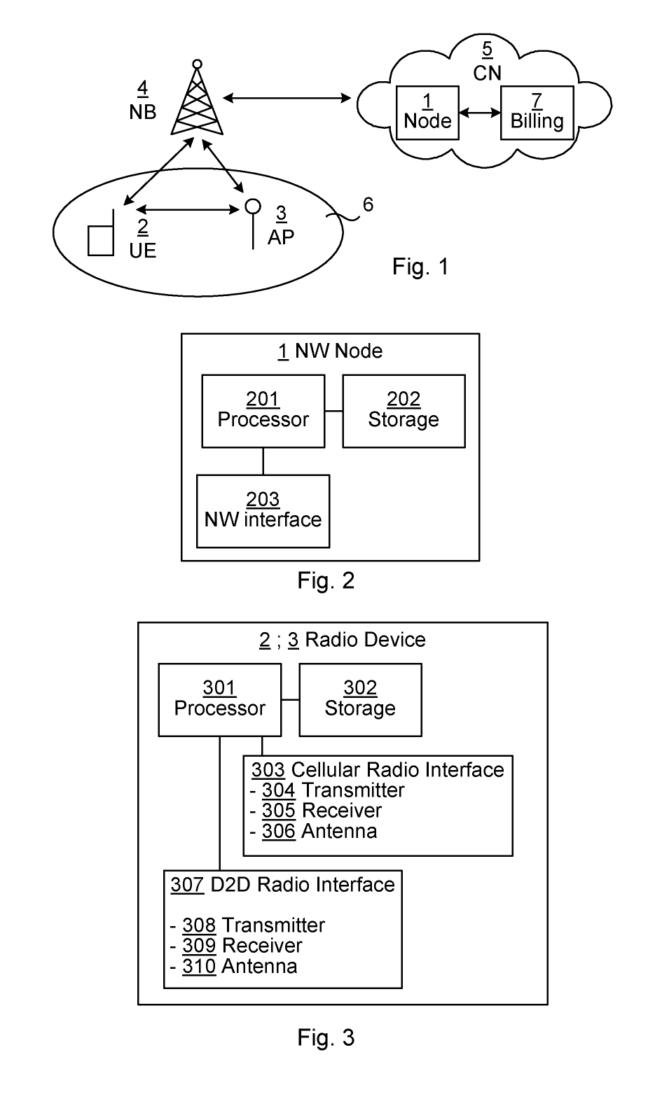

FIG. 1 schematically illustrates different parts/devices of the present disclosure and how they may interact with each other. A wireless transceiver 3, e.g. a Bluetooth or WLAN access point (AP), has a range 6 covering a geographical area (or volume). A radio device 2, e.g. a UE, is connected to communication network 5 (in FIG. 1 represented by a core network (CN) 5), via a cellular RAN 4, in FIG. 1 represented by a 3^{rd} Generation Partnership Project (3GPP) Node B (NB). The radio device may be any device or UE, mobile or stationary, enabled to communicate over a radio cannel in a communications network, for instance but not limited to e.g. mobile phone, smart phone, modem, sensors, meters, vehicles, household appliances, medical appliances, media players, cameras, or any type of consumer electronic, for instance but not limited to television, radio, lighting arrangements, tablet computer, laptop, or personal computer (PC). In accordance with the present disclosure, the communication network 5 is made aware when the radio device 2 gets within the range 6 of the wireless transceiver 3. As discussed herein, this may be e.g. by the radio device 2 sending a message to the communication network 5 via the cellular RAN 4 or the wireless transceiver 3 sending a message to the communication network 5 via e.g. a fixed (cable) network over the internet. The communication network 5 comprises a network node 1 which in accordance with the present disclosure is responsible for determining whether the radio device 2 is or has been in range 6 of the wireless transceiver 3 and for redirecting billing of the usage of the cellular communication i.e. communication between the device 2 and the core network 5 via the RAN node 4, as a result thereof. The redirecting of billing is done by signalling with one or more billing servers 7 in the communication network 5. In some embodiments, at least one of the billing server(s) 7 is part of the network node 1, but in some other embodiments the billing server(s) 7 is not part of the network node 1, possibly comprised in other node(s) in the communication network 5.

In some embodiments of the present disclosure, the redirecting at least some billing comprises redirecting the at least some billing for as long as the radio device 2 is in range of the wireless transceiver 3. Thus, the billing can be redirected for as long as the radio device e.g. is within an area covered by a WLAN or other hot spot. For example, the radio device 2 or the wireless transceiver 3 may periodically send an indication that the radio device 2 is within the range 6 for as long as the radio device is within range of the wireless transceiver 3, to the communication network 5 via the cellular RAN 4. Thus, when such an indication is no longer periodically received by the network 5, the redirecting of billing is terminated, e.g. billing the regular subscription of the radio device 2 instead.

In some embodiments of the present disclosure, the redirecting of at least some billing comprises redirecting the at least some billing during a predefined time period starting from the determining that the radio device 2 is within range of the wireless transceiver 3. As an example, the redirecting of billing can then start upon the radio device 2 passing the range 6 of a Bluetooth or radio frequency identification (RFID) transceiver 3 when entering e.g. a train or other means of transport in which e.g. free wireless connection is provided during a trip. A timer may run from the determining that the radio device 2 is within range 6, or the redirecting may be between set time points (e.g. from 1 pm to 3 pm for a two hour train journey) after the determining that the radio device 2 is within range 6 e.g. when entering the train. Hence, in this embodiment, the redirection of at least some billing is made even if the device goes out of range with the radio device 2 as long as the timer has not expired. The embodiment also covers the case that the redirection of at least some billing is made even if the device at the time instant of leaving the range with the radio device 2 is idle (w.r.t cellular communication, for instance idle mode in LTE or idle mode, URA_PCH, Cell_PCH in WCDMA/HSPA), and hence the redirection will continue even if the devices goes into active state (for instance RRC_connected in LTE or to WCDMA/HSPA or Cell FACH in WCDMA/HSPA) w.r.t cellular communication system at a time instant the device is outside range of the radio device but the timer has not expired.

In some embodiments of the present disclosure, the radio device 2 has said first subscription for billing use of resources via the cellular RAN 4, and said second subscription for billing use of resources via the cellular RAN 4 is associated with the wireless transceiver 3. The wireless transceiver may e.g. be deployed by a provider of wireless access, e.g. WLAN or other internet hot-spot, for accepting some or all billing of cellular resources within the range 6 e.g. when the hot-spot is overloaded. Thus, in some embodiments of the present disclosure, the second subscription for billing use of resources via the cellular RAN 4 is held by an operator of a WLAN associated with the wireless transceiver 3.

In some embodiments of the present disclosure, the wireless transceiver 3 is a Bluetooth transceiver; a wireless local area network, WLAN, transceiver; or a radio frequency identification, RFID, transceiver, where the wireless transceiver uses a radio communication technology for communicating with the radio device 2 which is different than a radio access technology (RAT) used by the cellular RAN 4. Thus, the wireless transceiver may for example not interfere with communication over the cellular RAN 4.

Alternatively, in some embodiments of the present disclosure, the wireless transceiver 3 is configured for communicating with the radio device 2 in network (NW) assisted device-to-device (D2D) communication, and the determining that the radio device 2 is within range 6 of the wireless transceiver 3 comprises determining whether the radio device 2 and the wireless transceiver 3 are in range for D2D communication, wherein the redirecting is based on said determining whether the radio device 2 and the wireless transceiver 3 are in range for D2D communication. The determining that the radio device 2 is in range for NW assisted D2D communication with the wireless transceiver 3 is one way of determining that the radio device is within the range 6 of the wireless transceiver 3. Actual D2D communication may not need to be set up. It may be sufficient to determine that the radio device 2 is in range for D2D communication, although some exchange of information via D2D communication may occur, at least one-way, in order for the radio device 2 and the wireless transceiver 3 to detect each other. Thus, the same RAT may be used, within existing D2D protocols, for determining whether the radio device 2 is within the range 6 as is used for communication via the cellular RAN 4.

In some embodiments, the wireless transceiver is a non-cellular wireless transceiver/access point.

In some embodiments of the present disclosure, the determining that a radio device 2 is within range of a wireless transceiver 3 comprises receiving a message from the wireless transceiver indicating that the radio device is within range 6 of the wireless transceiver. This is one way of informing the network 5 of the radio device 2 being within the range 6. The wireless transceiver 3 may detect the radio device 2 and e.g. obtain the media access control (MAC) address or other identifier or indicator of the radio device 2. The wireless transceiver may then forward the identifier in said message e.g. via the cellular RAN 4, thereby indicating to the network node 1 that the radio device 2 is within the range 6.

Additionally or alternatively, in some embodiments of the present disclosure, the determining that a radio device 2 is within range of a wireless transceiver 3 comprises receiving a message from the radio device indicating that it is within range of the wireless transceiver. This is another way of informing the network 5 of the radio device 2 being within the range 6. The radio device 2 may detect the wireless transceiver and e.g. obtain the media access control (MAC) address or other identifier or indicator of the wireless transceiver 3. The radio device may then forward the identifier in said message e.g. via the cellular RAN 4, thereby indicating to the network node 1 that the radio device 2 is within the range 6.

In some embodiments of the present disclosure, the at least some billing is for use of data traffic resources. Embodiments of the present disclosure may to be most beneficial for data traffic, since data traffic resources may typically be a limiting resource in wireless access e.g. WLAN.

Consider a device inside the coverage area where redirection of at least some billing is made as demonstrated above, where the device is leaving the coverage area, i.e. the premises as defined above. For the one committed to paying for traffic for a user being within the coverage area, it is of interest that the commitment of paying is enabled to be terminated. For the user, it is of interest that the termination of the commitment of paying is experienced as reasonable, which in turn also is of interest of the one committed to pay for the traffic since the commitment is at least partially of providing an experience of good service to the user. Thus, the technical approach of terminating the commitment of redirecting the at least some billing should strive towards a termination that is experienced as reasonable to both parties. For the case described in the background where an ongoing telephone call, i.e. voice call, is allowed to be finished, the technical approach is fairly evident. However, for data traffic, particularly for the very common case where the data traffic is bursty, the approach is not that evident. Consider for example a user checking the weather report when about to leave the area (e.g. to see if an umbrella should be brought) by browsing a web site providing the forecast divided in time, place or aspect of the weather by different pages. A burst of data is provided for one page, the user looks at that page (wherein idle state is present), the user, checks the forecast for e.g. for some time later, and a new data burst is provided (wherein connected state is present), etc.

The user would then consider it as bad service if the data traffic billing redirection was terminated in the middle of the weather forecast checking. On the other hand, the host would not be interested in having at least some of the billing redirected forever.

The detection of such an event may be indicated by loss of the short range communication (connection failure, according to protocol for the current used short range radio). In another embodiment this may be indicated to the NW node (billing node). For example, the radio device 2 or the wireless transceiver 3 may periodically send an indication that the radio device 2 is within the range 6 for as long as the radio device is within range of the wireless transceiver 3, to the communication network 5 via the cellular RAN 4. Thus, when such an indication is no longer periodically received by the network 5, the redirecting of billing is terminated, e.g. billing the regular subscription of the radio device 2 instead. In order to make a smooth transition of the billing in a way that the user experiences as fair, different approaches may be envisioned and covered by the invention. For instance;
A timer that is enabled once the NW have detected that the device is out of coverage (as described in detail above). The timer may be chosen such that it seems fair for the user, say in the range of minutes (a typical time to terminate a typical application). After the timer has expired, the billing is redirected to the subscription associated with the device.
Once the NW has detected that the device is out of coverage, the device is allowed to use a certain amount of data say 1-10 Mbyte. The amount of data may be determined as a reasonable amount such that ongoing application may not be interrupted (i.e. data corresponding to a typical home page size currently being down loaded). After the amount of data is used, the billing is redirected to the subscription associated with the device.
Once the NW has detected that the device is out of coverage, the device is allowed to end down/up load associated to the current application. For instance as long as data packets arriving to the device is originating from the same IP-address (indicating that a specific internet site is currently being down loaded), the billing is redirected according to as described above. However, once it is determine that the data packet comes from another IP-address, the billing is redirected to the subscription associated with the device.

In another embodiment, once the device is detected to leave the coverage area of the short range communication, a message may be transmitted to the device which on application level indicates for the user that the user is leaving to the area of free cellular connection. The user may then have a limited time, say 1 minute, before the billing is redirected to the subscription associated with the device. If the device again comes into coverage to the short range communication within this time (e.g. 1 minute), the redirection of billing to third part is continued, otherwise the billing is redirected to the subscription associated with the device. Combinations of the above examples are also feasible. For example, a set of limitations comprising maximum time and maximum data amount may be provided, wherein redirection of billing is terminated once any of these limitations is reached. This example may also be combined with the IP address limitation. The example with a notification that indicates for the user that the user is leaving the area of free or reduced fee cellular connection may also be combined with a set of limitations as demonstrated above. Furthermore, the notification may comprise a greeting or advertisement from the host. That is, when it is determined from signalling over the cellular RAN 4 and/or with the wireless transceiver 3 that the radio device 2 is no longer within the range 6 of the wireless transceiver 3, i.e. a first occurred event, a second event will terminate the re-direction of billing. The second event is monitored by assigning a limitation criterion for the redirecting 402 of the at least some billing associated with the data communication over the cellular RAN for resources used by the radio device 2, wherein the second event is considered occurred when that limitation criterion if fulfilled. When the second event has occurred, the redirecting 402 of the at least some billing associated with data communication over the cellular RAN for resources used by the radio device 2 is terminated through signalling with the one or more billing servers 7 connected to the communication network.

FIG. 2 schematically illustrates an embodiment of a NW node 1 of the present disclosure. The NW node 1 comprises a processor/processor circuitry 201 e.g. a central processing unit (CPU). The processor 201 may comprise one or a plurality of processing units in the form of microprocessor(s). However, other suitable devices with computing capabilities could be comprised in the processor 201, e.g. an application specific integrated circuit (ASIC), a field programmable gate array (FPGA) or a complex programmable logic device (CPLD). The processor 201 is configured to run one or several computer program(s) or software stored in a storage unit 202 e.g. a memory. The storage unit is regarded as a computer readable means and may e.g. be in the form of a Random Access Memory (RAM), a Flash memory or other solid state memory, or a hard disk. The processor 201 is also configured to store data in the storage unit 202, as needed. The NW node 1 also comprises a network interface 203 for communication with other parts of the communication NW 5 and/or the cellular RAN 4.

The rating, charging and billing of the network node 1 may be implemented as an application server in the network 5. The security level is preferably high to prevent fraud problems and to support authentication, authorization, and accounting. Relevant parameters are sent from involved devices (e.g. radio device 2 and/or wireless transceiver 3, as well as billing server(s) 7) and network elements. To improve the flexibility, both for cost calculation and sharing calculation and to be able to combine conditions for parameters, many parameters may be added and provided, when applicable, such as MAC-addresses, device identifiers, cost sharing parameters, secure token and device capabilities, but not limited to these.

FIG. 3 schematically illustrates a radio device 2 or a wireless transceiver 3 (in reference to FIG. 3 generally referred to as radio device 2; 3) of the present disclosure. The radio device 2; 3 comprises a processor/processor circuitry 301 e.g. a central processing unit (CPU). The processor 301 may comprise one or a plurality of processing units in the form of microprocessor(s). However, other suitable devices with computing capabilities could be comprised in the processor 301, e.g. an application specific integrated circuit (ASIC), a field programmable gate array (FPGA) or a complex programmable logic device (CPLD). The processor 301 is configured to run one or several computer program(s) or software stored in a storage unit 302 e.g. a memory. The storage unit is regarded as a computer readable means and may e.g. be in the form of a Random Access Memory (RAM), a Flash memory or other solid state memory, or a hard disk. The to processor 301 is also configured to store data in the storage unit 302, as needed. The radio device 2, and optionally the wireless transceiver 3, comprises a radio interface 303 for communication over the cellular RAN 4. The cellular radio interface 303 comprises a transmitter 304, a receiver 305 and an antenna 306, which may be combined to form a transceiver or be present as distinct units within the radio device 2; 3. The transmitter 304 is configured to cooperate with the processor to transform data bits to be transmitted over an air interface to a suitable radio signal in accordance with the radio access technology (RAT) used by the Radio Access Network (RAN) 4 via which the data bits are to be transmitted. The receiver 305 is configured to cooperate with the processor 301 to transform a received radio signal to transmitted data bits. The antenna 306 may comprise a single antenna or a plurality of antennas, e.g. for different frequencies and/or for MIMO (Multiple Input Multiple Output) communication. The antenna 306 is used by the transmitter 304 and the receiver 305 for transmitting and receiving, respectively, radio signals. Similarly, the radio device 2; 3 may comprise a radio interface 307 for communication with the wireless transceiver 3 or the radio device 2, respectively, here called a D2D radio interface 307. The D2D radio interface may be configured for communication via e.g. Bluetooth, RFID or NW assisted D2D RAT. The D2D radio interface 307 comprises a transmitter 308, a receiver 309 and an antenna 310, which may be combined to form a transceiver or be present as distinct units within the radio device 2; 3. The transmitter 308 is configured to cooperate with the processor to transmit data bits in accordance with the radio access technology (RAT) used.

The receiver 309 is configured to cooperate with the processor 301 to receive data bits. The antenna 310 may comprise a single antenna or a plurality of antennas, e.g. for different frequencies and/or for MIMO communication. The antenna 310 is used by the transmitter 308 and the receiver 309 for transmitting and receiving, respectively, radio signals.

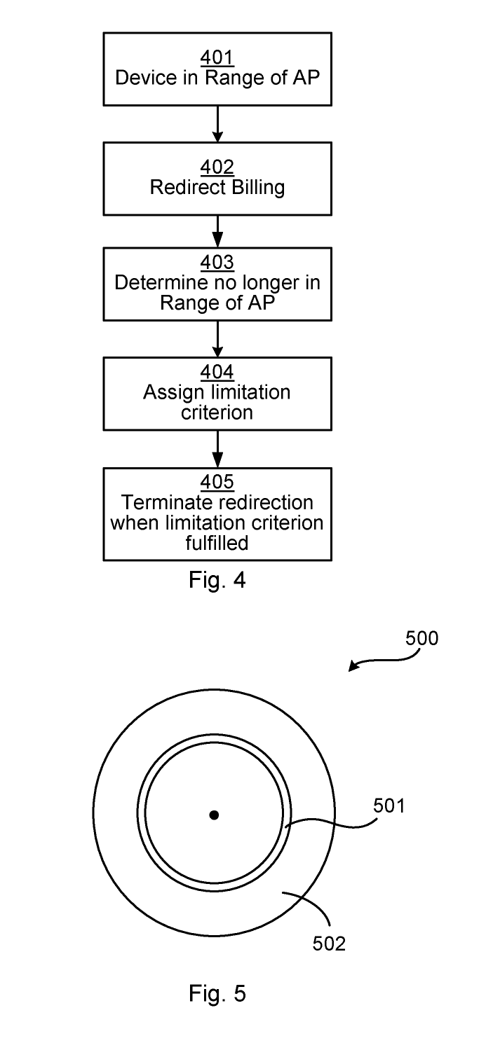

FIG. 4 is a schematic flow chart of an embodiment of a method of the present disclosure. The method is performed by/in the network node 1 in the communication network 5. The radio device 2 is determined 401 to be within range 6 of the wireless transceiver 3 by means of signalling with the cellular RAN 4 and/or the wireless transceiver 3. The radio device 2 is connected to the communication network over the cellular RAN 4. At least some billing for resources used by the radio device 2 via the cellular RAN is redirected 402 from a first subscription to a second subscription through signalling with the one or more billing servers 7 connected to the communication network 5, as a result of said determining 401 that the radio device 2 is within range of the wireless transceiver 3. Thereafter, it is determined 403 from signalling over the cellular RAN 4 and/or with the wireless transceiver 3 that the radio device 2 is no longer within the range 6 of the wireless transceiver 3, and then there is assigned 404 a limitation criterion for the redirecting 402 of the at least some billing associated with the data communication over the cellular RAN for resources used by the radio device 2, and the redirecting 402 of the at least some billing associated with data communication over the cellular RAN for resources used by the radio device 2 is terminated 405, through signalling with the one or more billing servers 7 connected to the communication network, when the limitation criterion is fulfilled.

FIG. 5 illustrates a computer program product 500. The computer program product 500 comprises a computer readable medium 502 comprising a computer program 501 in the form of computer-executable components 501. The computer program/computer-executable components 501 may be configured to cause a network node 1, a radio device 2 or a wireless transceiver 3, e.g. as discussed above, to perform an embodiment of a method of the present disclosure. The computer program/computer-executable components may be run on the processor 201 or 301 for causing the network node 1, radio device 2 or wireless transceiver 3, respectively, to perform the method. The computer program product 500 may e.g. be comprised in a storage unit or memory 202 or 302 comprised in the network node 1, radio device 2 or wireless transceiver 3 and associated with the processor 201 or 301. Alternatively, the computer program product 500 may be, or be part of, a separate, e.g. mobile, storage means, such as a computer readable disc, e.g. CD or DVD or hard disc/drive, or a solid state storage medium, e.g. a RAM or Flash memory.

### EXAMPLE 1

In this example there is user with a UE 2, and this user enters into a public place which offers free wireless access, e.g. a restaurant. Today, this would typically imply that Wi-Fi was installed and that either it was free for everyone or that a user obtains access credentials (user name and password) to access. The former is often the case in cafés while the latter might be more common on trains and in airports or hotels.

According to the present disclosure, free wireless access might be obtained in a completely different way, namely by using the regular wireless connection via the cellular RAN 4 and only ensure that this becomes free of charge for the user by redirecting 402 billing. The present disclosure is related to various ways of determining 401 when a UE 2 can use the regular cellular connection while the cost for this usage should be taken by someone else, i.e. the second subscription.

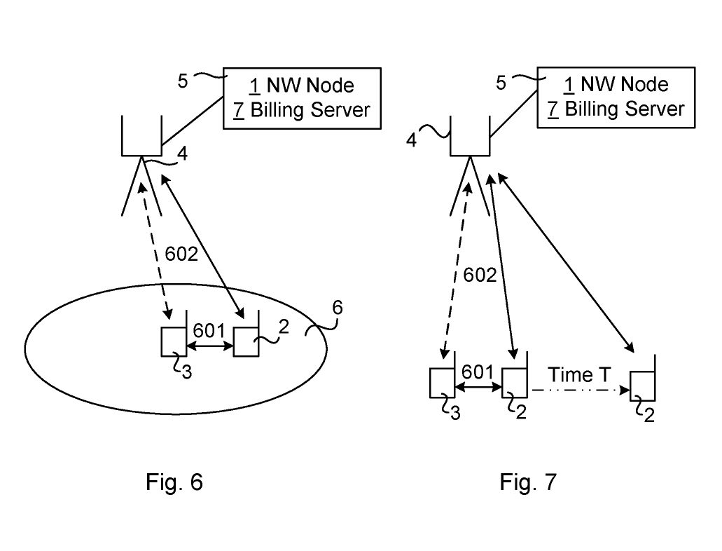

In an embodiment, as exemplified in FIG. 6, the free wireless connection obtained in this way is based on location. As an example, suppose a user enters a café which provides free wireless access. The café has a Bluetooth transceiver 3 which broadcasts its device address or other indicator. Once the UE 2 can receive 601 this broadcast address it connects and obtains the indicator specific for this café. The indicator is sent 602 to the network 5 via the cellular RAN 4 and the network then knows that the UE 2 is within this café (or more precisely knows that it is in range of the Bluetooth transceiver 3 installed at the café). Once the network has this knowledge, the connection to UE 2 will remain the same but the cost will be billed to the café holding the second subscription instead of to the user holding the first subscription.

Alternatively, the example embodiment is altered such that the sending 602 of the indicator to the network 5 is not done by the UE 2, but by the wireless transceiver 3 in the café. The effect would be the same and the change of billed subscription would be seamless for the user.

Alternatively, the determining 401 is based on RFID and is done at the entrance to the café. As long as the radio device 2 is within the café, the to billing will be covered by the café, and once the device leaves the café, the billing will return to the user subscription. RFID is here again assumed to be used at the exit from the café. This alternative embodiment is not limited to the use of RFID, but RFID serves as a good example.

Optionally, time-limited free wireless access is provided. This is applicable to all example embodiments above, and the way it can work is that once a UE 2 is within range 6 and obtains the valid indicator, the indicator is associated with a timer and the free access is only provided until the times expires.

Returning to the example with the café, the redirection might be initiated once it is determined that UE 2 is within range, but the free service offered by the cafémight be limited to, say, 20 minutes, to reduce the risk that people merely stay at the café to get free internet access. That is, the first event as described above may then occur more or less at the same time as the re-directing of billing starts and the timer for the second event as described above is set to the limitation in time, e.g. the 20 minutes as discussed above.

### EXAMPLE 2

In the embodiments of example 2, illustrated in FIG. 7, applicable for instance to the situation when free wireless access is provided on a train, the duration of the free access matches the duration of the trip. For instance, a timer is set such that the data communication is free as long as the timer has not expired, and the timer is substantially equal to the duration of the trip.

Similar as demonstrated for example 1 above, the first event may then be considered to occur when the trip starts and the timer for the second event is set to the expected duration of the trip. Here, in case of any train delays, the timer may be reset, implying new signalling with the one or more billing servers 7 connected to the communication network, such that the redirecting lasts for the entire time of the trip. Furthermore, the timer may here be set to last longer than the trip at train delays as a compensation for any inconvenience of the delayed train. Assuming an electronic ticket, it is known when the trip starts and ends, and meanwhile the billing for the wireless to access should be covered by the train company holding the second subscription. In an alternative embodiment, the billing is not entirely taken by the second subscription, but instead split between the first subscription of the user and the second subscription of the train company, for instance, the second subscription takes 30% of the cost for a package of services e.g. data usage or just weather-forecast etc., and the first subscription takes 70%. Also here, adaptions may be made as compensations for inconvenience of train delays. E.g. during the ordinary trip time, the constraints for redirection may be applied, but for delay time, full redirection of cost may be made. The cost sharing can be set by pre-set values, in prepaid/postpaid/convergent/online charging systems (OCS) or similar, or indicator can be provided in the setup, at setup of the session, with new parameters sent from the units involved which provides other relevant information further to the network 5 as a base for cost sharing. Also in this example, the redirection of at least some billing is made even if the device goes out of range with the radio device 2 as long as the timer has not expired. The example also covers the case that the redirection of at least some billing is made even if the device at the time instant of leaving the range with the radio device 2 is idle (w.r.t cellular communication, for instance idle mode in LTE or idle mode, URA_PCH, Cell_PCH in WCDMA/HSPA), and hence the redirection will continue even if the device goes into active state (for instance RRC_connected in LTE or WCDMA/HSPA or Cell_FACH in WCDMA/HSPA) w.r.t cellular communication system at a time instant the device is outside range of the radio device but the timer has not expired.

### EXAMPLE 3

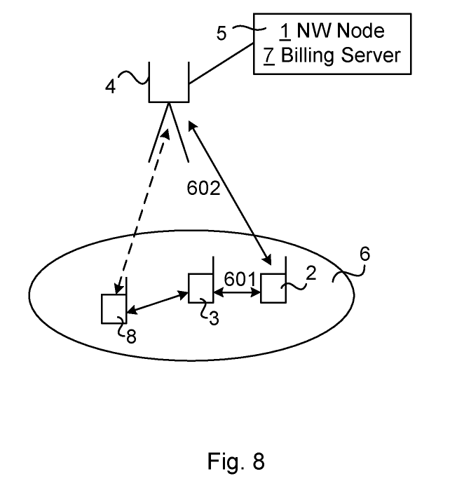

In the embodiments of example 3, illustrated in FIG. 8, the billing model is somewhat different. In this scenario a second transceiver 8 takes the billing of the data usage of the radio device 2. Hence, the wireless transceiver 3 only acts as a unit broadcasting information and the billing is taken by a second transceiver 8, which may be wired or wireless. The second transceiver 8 is associated with the second subscription and contacts the wireless transceiver 3 and sends over the indicator specific for the second subscription the wireless transceiver 3. Then in turn, the wireless transceiver 3 broadcasts the indicator and once the radio device 2 has detected the wireless transceiver 3, it sends the received indicator (e.g. address/credential/authentication code etc.) to the NW node 1 that fed the information to the billing server 7 responsible for the billing. Now, the data traffic of the radio device 2 over the cellular access is billed on the second subscription of the second transceiver 8. Alternatively, the second transceiver 8 is pre-loaded with information (e.g. the indicator) about the wireless transceiver 3 and hence no D2D interaction between the second transceiver 8 and the wireless transceiver 3 is needed. The indicator might instead for instance be fed over a NW communication between the second transceiver 8 and the wireless transceiver 3. The third party billing approach described may also be applicable to the other above described examples.

### EXAMPLE 4

The above examples have been described under the assumption that all data is going over the cellular RAN 4, and either the billing or the data rate might be changed due to one or several parameters, for instance location information. The idea is naturally also applicable in case e.g. WLAN is available and perhaps used as the default RAT. Taking the example with the train, WLAN might be the preferred choice and only if the obtained quality does not meet certain requirements, the radio device 2 is handed r to the cellular RAN 4 where the cellular RAN then is free of charge since the train company will take the cost.

### EXAMPLE 5

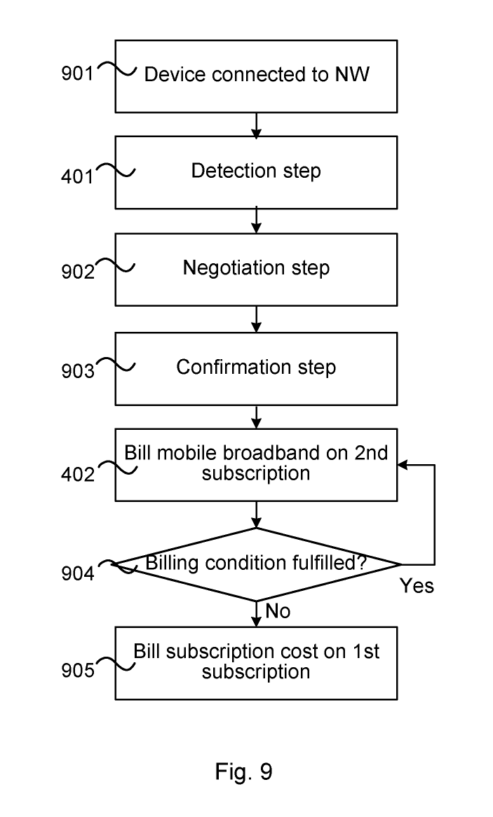

A generic flow chart over an embodiment of a method of the present disclosure can be seen in FIG. 9. A radio device 2 (UE, modem, sensor, tablet, smart-phone or the like) is conncted 901 to a cellular RAN node 4 (Long m Evolution (LTE)/High Speed Data Access (HSPA), Enhanced Data rates for Global System for Mobile Communications (GSM) Evolution (EDGE) or the like) and the regular subscription of the radio device 2 is billed for wireless access. Then there is a detection step, where the radio device 2 detects a wireless transceiver 3 offering free mobile broadband access, thus determining 401 that the radio device 2 is in range 6 of said wireless transceiver 3. The determining 401 is e.g. done according to any of the embodiments discussed above. Then a negotiation step 902 is performed, where a billing unit 1, 7 in the NW 5 is informed about that the second subscription of the wireless transceiver 3 takes over the cost of mobile broadband for the radio device 2 having the first subscription. Once a confirmation 903 is made (may be for instance a text message (SMS, short message service) to the radio device 2 stating that the cost of mobile broadband is taken by the second subscription, and is valid under certain conditions, as exemplified above), the billing unit 1, 7 redirects 402 the billing for the mobile broadband traffic for the radio device 2 on the second subscription. This is valid as long as the billing condition is fulfilled 904. Again, billing conditions may be as described in the examples above. Once the condition is not fulfilled 904 anymore the billing for mobile broadband of the radio device 2 is redirected 905 back to the first subscription, i.e. when the first and second events as demonstrated above has occurred 403-405.

Below follow some other aspects of the present disclosure.

According to another aspect of the present disclosure, there is provided a network node 1 for a communication network 5. The network node comprises means 201 foetermining 401 from signalling with over a cellular RAN 4 and/or with a wireless transceiver 3 that a radio device 2 is within range 6 of the wireless trnsceiver 3 said radio device 2 being connected to the communication network over the cellular RAN 4. The network node also comprises means 201 for redirecting 402, through signalling with one or more billing servers 7 connected to the communication network, at least some billing for resources used by the radio device 2 via the cellular RAN, from a first subscription to a second subscription, as a result of said determining 401 that the radio device is within range of the wireless transceiver 3, and the terminating of the redirection is performed as demonstrated above.

According to another aspect of the present disclosure, there is provided a to radio device 2. The radio device comprises communication circuitry 303, 307 enabled for signalling with a cellular RAN 4 and a wireless transceiver 3. The radio device also comprises processor circuitry 301, and a storage unit 302 storing instructions that, when executed by the processor circuitry, cause the radio device to receive a first radio message from the wireless transceiver, said first radio message comprising an indicator for redirecting at least some billing for resources used by the radio device via the cellular RAN. The instructions also cause the radio device to send a second radio message to the communication network via the cellular RAN. The second radio message comprises the indicator from the wireless transceiver, thereby indicating to the communication network that the radio device is in range of the wireless transceiver and that said at least some billing should be redirected from a first subscription to a second subscription.

According to another aspect of the present disclosure, there is provided a radio device 2. The radio device comprises means 301, 307 for receiving 601 a first radio message from a wireless transceiver 3, said first radio message comprising an indicator for redirecting at least some billing for resources used by the radio device 2 over a cellular RAN 4. The radio device also comprises means 301, 303 for sending 6 a second radio message to the communication network 5 over the cellular RAN 4, said second radio message comprising the indicator from the wireless transceiver 3, thereby indicating to the communication network that the radio device 2 is in range 6 of the wireless transceiver and that said at least some billing should be redirected from a first subscription to a second subscription.

According to another aspect of the present disclosure, there is provided a wireless transceiver 3. The wireless transceiver comprises communication circuitry 303, 307 enabled for signalling with a cellular RAN 4 and a radio device 2. The wireless transceiver also comprises processor circuitry 301, and a storage unit 302 storing instructions that, when executed by the processor circuitry, cause the wireless transceiver to receive a first radio message from a to radio device connected to a communication network via the cellular RAN. The first radio message comprises an indicator for redirecting at least some billing for resources used by the radio device via the cellular RAN. The instructions also cause the wireless transceiver to send a second radio message to the communication network, said second radio message comprising the indicator from the radio device, thereby indicating to the communication network that the radio device is in range of the wireless transceiver and that said at least some billing should be redirected from a first subscription to a second subscription.

According to another aspect of the present disclosure, there is provided a wireless transceiver 3. The wireless transceiver comprises means 301, 307 for receiving 601 a first radio message from a radio device 2, connected to a communication network 5 over a cellular RAN 4, said first radio message comprising an indicator for redirecting at least some billing for resources used by the radio device 2 over the cellular RAN 4. The wireless transceiver also comprises means 301, 303 for sending 602 a second radio message to the communication network 5, said second radio message comprising the indicator from the radio device 2, thereby indicating to the communication network that the radio device is in range 6 of the wireless transceiver and that said at least some billing should be redirected from a first subscription to a second subscription.

The termination of the redirecting of billing for these embodiments are also performed as demonstrated above.

The present disclosure has mainly been described above with reference to a few embodiments. However, as is readily appreciated by a person skilled in the art, other embodiments than the ones disclosed above are equally possible within the scope of the present disclosure, as defined by the appended claims.

1-17. (canceled)

18. A method in a network node of a communication network, the method comprising:
determining from signaling over a cellular radio access network (RAN) and/or with a wireless transceiver that a radio device is within range of the wireless transceiver, said radio device being connected to the communication network over the cellular RAN;
redirecting, through signaling with one or more billing servers connected to the communication network, at least some billing associated with data communication over the cellular RAN for resources used by the radio device over the cellular RAN, from a first subscription to a second subscription, as a result of said determining that the radio device is within range of the wireless transceiver, whereafter
determining from signaling over the cellular RAN and/or with the wireless transceiver that the radio device is no longer within the range of the wireless transceiver, and then
assigning a limitation criterion for the redirecting of the at least some billing associated with the data communication over the cellular RAN for resources used by the radio device; and
terminating, through signaling with the one or more billing servers connected to the communication network, the redirecting of the at least some billing associated with data communication over the cellular RAN for resources used by the radio device when the limitation criterion is fulfilled.

19. The method of claim 18, wherein the limitation criterion comprises a predefined time period starting from the determining that the radio device was within range of the wireless transceiver.

20. The method of claim 18, wherein the limitation criterion comprises a set of limitations comprising any combination of:
a maximum time;
a maximum data amount; and
a limitation to an IP address,
wherein the redirecting is terminated once any of the limitations of the set of limitations is reached.

21. The method of claim 18, further comprising
transmitting a notification to the radio device when it is determined from the signaling over the cellular RAN and/or with the wireless transceiver that the radio device is no longer within the range of the wireless transceiver.

22. The method of claim 21, wherein the notification includes information about a set of limitations comprising any combination of: a maximum time; a maximum data amount; and a limitation to an IP address.

23. The method of claim 18, wherein the radio device has said first subscription for billing use of resources via the cellular RAN, and said second subscription for billing use of resources via the cellular RAN that is associated with the wireless transceiver.

24. The method of claim 23, wherein said second subscription for billing use of resources via the cellular RAN is held by an operator of a wireless local area network (WLAN) associated with the wireless transceiver.

25. The method of claim 18, wherein the wireless transceiver is using a radio communication technology for communicating with the radio device that is different than a radio access technology (RAT) used by the cellular RAN.

26. The method of claim 18, wherein the wireless transceiver is configured for communicating with the radio device in network assisted peer device-to-device (D2D) communication, and determining that the radio device is within range of the wireless transceiver comprises determining whether the radio device and the wireless transceiver are in range for peer D2D communication, wherein the redirecting is based on said determining whether the radio device and the wireless transceiver are in range for peer D2D communication.

27. The method of claim 18, wherein determining that the radio device is within range of the wireless transceiver comprises receiving a message from the wireless transceiver indicating that the radio device is within range of the wireless transceiver.

28. The method of claim 18, wherein determining that the radio device is within range of the wireless transceiver comprises receiving a message from the radio device indicating that it is within range of the wireless transceiver.

29. A network node for a communication network, the network node comprising:
communication circuitry configured for signaling over a cellular radio access network (RAN) signaling and/or with a wireless transceiver and with one or more billing servers connected to the communication network;
processor circuitry; and
a storage unit storing instructions that, when executed by the processor circuitry, cause the node to:
determine from signaling over the cellular RAN and/or with the wireless transceiver that a radio device is within range of the wireless transceiver, said radio device being connected to the communication network over the cellular RAN;
redirect, through signaling with the one or more billing servers connected to the communication network, at least some billing associated with data communication over the cellular RAN for resources used by the radio device over the cellular RAN, from a first subscription to a second subscription, as a result of said determining that the radio device is within range of the wireless transceiver; and thereafter to
determine from signaling over the cellular RAN and/or with the wireless transceiver that the radio device is no longer within the range of the wireless transceiver; and then to
assign a limitation criterion for the redirecting of the at least some billing associated with the data communication over the cellular RAN for resources used by the radio device; and
terminate, through signaling with the one or more billing servers connected to the communication network, the redirecting of the at least some billing associated with data communication over the cellular RAN for resources used by the radio device when the limitation criterion is fulfilled.

30. The network node of claim 29, wherein the limitation criterion comprises a predefined time period arranged to start from the determination that the radio device was within range of the wireless transceiver.

31. The network node of claim 29, wherein the limitation criterion comprises a set of limitations comprising any combination of:
a maximum time;
a maximum data amount; and
a limitation to an IP address,
wherein the redirection is terminated once any of the limitations of the set of limitations is reached.

32. The network node of claim 29, further arranged to:
transmit a notification to the radio device when it is determined from the signaling over the cellular RAN and/or with the wireless transceiver that the radio device is no longer within the range of the wireless transceiver.

33. The network node of claim 32, wherein the notification includes information about a set of limitations comprising any combination of: a maximum time; a maximum data amount; and a limitation to an IP address.

34. A computer-readable storage medium storing a computer program comprising instructions that, when run on processor circuitry in a network node, cause the processor circuitry to:
determine from signaling over the cellular RAN and/or with the wireless transceiver that a radio device is within range of the wireless transceiver, said radio device being connected to the communication network over the cellular RAN;
redirect, through signaling with the one or more billing servers connected to the communication network, at least some billing associated with data communication over the cellular RAN for resources used by the radio device over the cellular RAN, from a first subscription to a second subscription, as a result of said determining that the radio device is within range of the wireless transceiver; and thereafter to
determine from signaling over the cellular RAN and/or with the wireless transceiver that the radio device is no longer within the range of the wireless transceiver; and then to
assign a limitation criterion for the redirecting of the at least some billing associated with the data communication over the cellular RAN for resources used by the radio device; and
terminate, through signaling with the one or more billing servers connected to the communication network, the redirecting of the at least some billing associated with data communication over the cellular RAN for resources used by the radio device when the limitation criterion is fulfilled.
